(19) United States
(12) Patent Application Publication
(10) Pub. No.: US 2026/0225296 A1
(43) Pub. Date: Aug. 6, 2026

(54) Insert for Hot runner

(71) Applicant: INGLASS S.P.A., San Polo di Piave (IT)

(72) Inventors: Damiano BOZ JACOB, San Polo di Piave (IT); Enrico VEDELAGO, San Polo di Piave (IT); Massimo BISETTO, San Polo di Piave (IT)

(21) Appl. No.: 19/634,201

(22) Filed: Mar. 31, 2026

Related U.S. Application Data
(63) Continuation of application No. 17/472,643, filed on Sep. 12, 2021, now abandoned.

(30) Foreign Application Priority Data
Sep. 16, 2020 (IT) 102020000021799

(51) Int. Cl. B29C 45/27

(52) U.S. Cl. CPC B29C 45/2711

(57) ABSTRACT

An insert adapted to be placed at the gate of an injection molding machine around a tip of a molten material injector, comprising a cup-shaped first element, that delimit a first opening for housing the injector body and a bottom centrally provided with a second opening, and a second element, provided with a third central opening having a major dimension that is smaller than that of the second opening, wherein the second element is connectable to the bottom so that the second and third opening are aligned.

### TECHNICAL FIELD

The invention relates to a hot runner insert.

### BACKGROUND

In an injection molding machine, a manifold distributes molten material to a plurality of nozzles of a hot runner. As mentioned in US7025585B2, a heat transfer at the gate area remains a problem to overcome and an ongoing obstacle to improving cycle times. In particular injection molding systems, with specific materials to be injected, provided with hot runner or not, with or without a valve stem (pin), the temperature of the injection area (injector gate/nozzle) into the cavity or mold must be controlled, i.e. the injection area must be cooled. In addition, the heat present around the nozzle gate, necessary for injection, must not be transmitted to the mold plates, thus to the cavity, because it would compromise the correct cooling process of the manufactured object, triggering surface defects or long (non-productive) cooling times.

US7025585B2 describes an insert having a thermal shielding function at the nozzle tip to limit heat transmission from the hot runner's nozzle tip near the gate area to the mold plate. Referring ibidem to FIG. 3, the heat transmission from the tip 28, 30 to the plate31 occurs through the element 46 of a cooled insert 24. The cooled insert 24 is secured in the plate 31 by the overlap of another plate 33. In FIG. 8, the cooled insert 24 is divided into two portions that are supported against each other: the upper portion 70 and the lower portion 24d, between which a hollow pocket is provided in which to insert insulating material. No fastening means are provided.

The main object of the invention is to improve this state of the art.

Another object is to create a new insert that is housed or can be housed in the mold plate and inside which an injector tip is inserted or can be inserted, in order to control the operating temperatures of the tip itself and to control the transmission of heat towards the mold plate, therefore towards the cavity.

A coolable insert is proposed to be arranged at the gate of an injection molding machine around a tip of a molten material injector, comprising or consisting of

a cup-shaped first element comprising or consisting of

side walls that delimit a first (in use, upper) opening for housing the injector body, and

a bottom equipped centrally with a second opening,

a second element, equipped with a third central opening having a major dimension (or diameter) that is smaller than that of the second opening,

the second element being connectable to said bottom so that the second and third opening are aligned.

According to a preferred variant, the second element is connectable to the edges of the second opening, or to attachment points on the first element that are located at the bottom of the first element.

According to a preferred variant, the second element comprises a circular bushing-shaped portion on the outer lateral surface of which a thread is provides, and the circular bushing-shaped portion extends with a tapered portion which at the apex centrally comprises the third opening.

According to a preferred variant, the first element comprises an axis of substantial symmetry which is orthogonal to said bottom and passing through the center of the first and second openings, and the second element is movably connected to the first element so as to be able to move along said axis and thus adjust its own relative position with respect to the first element.

According to a preferred embodiment, the first and second elements comprise respective threads through which they can be coupled by screwing one with the other. Thanks to the mutual screwing, the relative position adjustment of the second element with respect to the first element is achieved.

In particular, the threading of the first element is placed:

on the edges of the second opening and/or

on the outer or inner lateral surface of a circular bushing-shaped portion in the center of which the second opening.is arranged.

In particular, the threading of the second element is arranged

on the inner lateral surface of a circular bushing-shaped portion, and/or

on the outer lateral surface of a circular bushing-shaped portion,

the circular bushing-shaped portion extending with a tapered (e.g. conical) portion that at the apex centrally comprises the third opening.

According to a preferred variant, the first and second elements comprise two respective circular mutual-abutment areas. In particular, the circular abutment area of the first element is located on the outer surface of said bottom. Thus, the first and second elements are couplable by mounting the second element on the outside of the bottom and then screwing them together.

According to a different preferred variant, the first and second elements are structured so that the second element is snugly insertable into, and can completely pass through, the second opening. Thus, the first and second elements are couplable by inserting the second element inside the bottom and then screwing them together.

According to a preferred variant, the outer surface of the lateral walls of the first element comprise one or more grooves for cooling fluid.

Various mounting methods are possible for the above-mentioned insert.

According to a preferred variant, the insert is mounted in a complementary cavity of a first plate. A second plate, provided with a pass-through opening delimited by edges, is directly superimposed on the first plate so that said pass-through opening is coaxial to the insert and said edges abut against the upper end of the side walls of the first element, blocking it.

According to another preferred variant, the insert is mounted in a complementary cavity of a plate, a ring being

directly superimposed on, and abutting against, the upper end of the lateral walls of the first element, and

fixed to the plate, e.g. by means of fasteners such as screws.

Another aspect of the invention relates to an injection molding machine comprising.

a molten material injector comprising a tip,

a plate comprising a cavity with an injection nozzle,

an insert according to any of the variants defined above, wherein

the tip is housed inside the insert and the insert is housed inside the cavity.

### BRIEF DESCRIPTION OF THE DRAWINGS

The advantages of the invention will be even clearer from the following description of a coolable insert, making reference to the attached drawing in which

FIG. 1 shows a three-dimensional view of an insert,

FIG. 2 shows a cross-sectional view of the insert from FIG. 1 mounted together with an injection tip;

FIG. 3 shows a cross-sectional view of a second insert mounted together with an injection tip;

FIG. 4 and 5 show a cross-sectional view of an insert assembled according to a different method.

### DETAILED DESCRIPTION

In the figures equal elements are indicated by equal numbers. Terms such as lower and upper refer to the elements as in use.

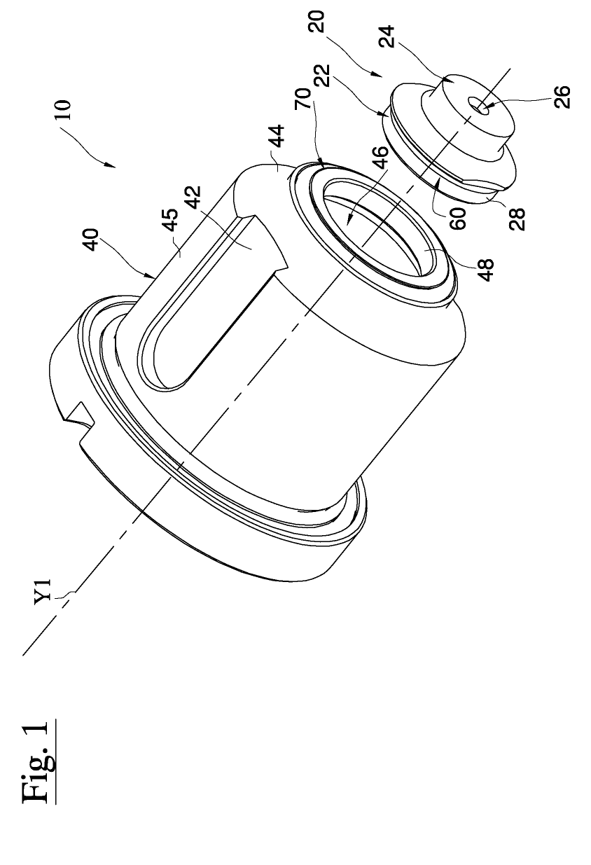

Referring to FIG. 1, a coolable insert 10 comprises the assembly of a lower element 20 and an upper element 40.

The element 40 is cup-shaped with cylindrical walls 45 and a bottom 44 centrally provided with an opening 46. Essentially, the element 40 has a symmetrical shape about a central axis Y1, which passes through the center of the opening 46.

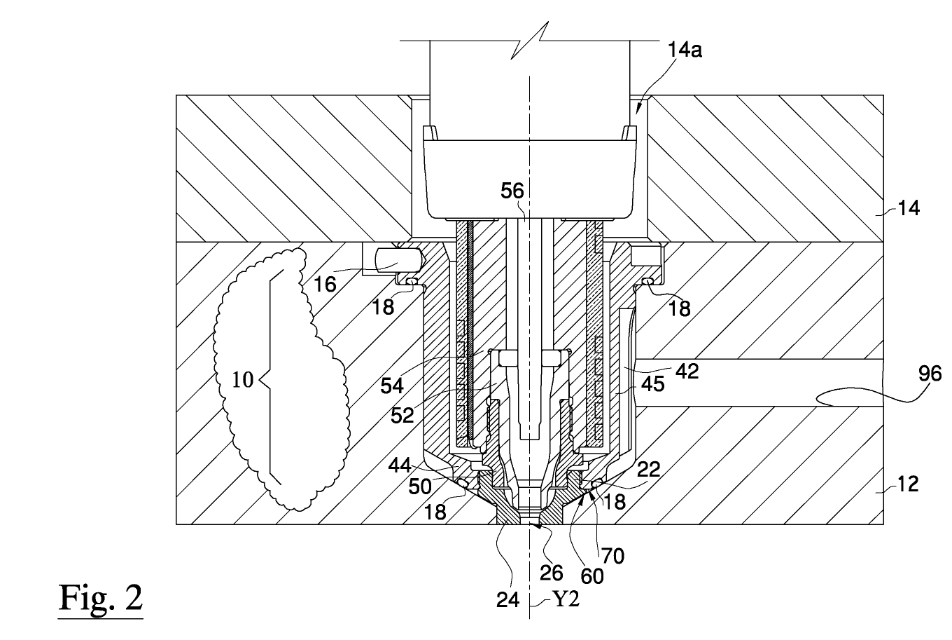

The element 40 has a side groove 42, connected to a channel 96 (see FIG. 2), for the passage of a cooling fluid, and a pair of seals or O-ring seals 18. A channel 96 for entry of water is shown in the figures, there being an exit channel (not shown) e.g. in a symmetrical or diametrically opposite position

The edges of the opening 46 comprise a thread 48 (not shown).

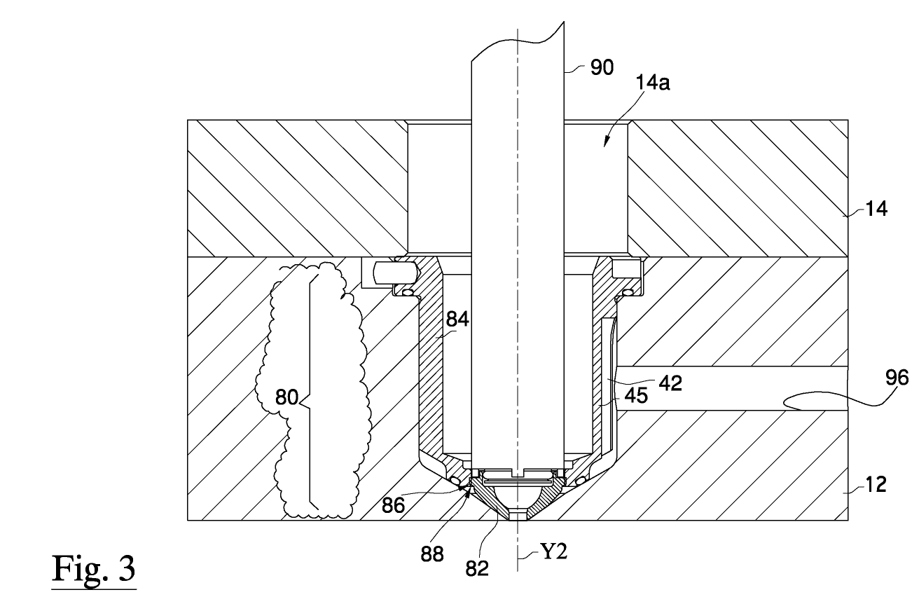

The element 20 comprises a circular bushing-shaped portion 22 that is prolonged by a tapered (e.g. cylindrical (see FIG. 2) or conical (see FIG. 3)) portion 24, which at the apex centrally comprises an opening 26. The element 20 also has a substantially symmetrical shape about a central axis Y1, which passes through the center of the opening 26.

The opening 46 has a larger diameter than that of the opening 26, while the circular bushing-shaped portion 22 comprises on its outer lateral surface a thread 28 that is complementary to the thread 48.

By screwing the threads 28, 48 one on top of the other, the element 20 is connectable to the bottom 44 so that the openings 26, 46 are aligned. Thus, the two elements 40, 20 joined together form a seat exploited to insert the injector within which the molten material flows.

FIG. 2 shows the assembly of the coolable insert 10 in an injection molding machine.

The coolable insert 10 is housed in contact with the inner surface of a cavity formed in a mold plate 12. The cavity of the mold plate 12 has symmetry axis Y2, The coolable insert 10 is fixed in the cavity by superimposing a plate 14, and e.g. by an anti-rotation dowel 16, and so that the axes Y1 and Y2 are parallel, in particular coincident.

The circular bushing-shaped portion 22 internally guides and is in contact with a ferrule 50, which in turn is fixed to an injector 54 capable of holding a tip 52. The latter guides a stem (pin) 56 to regulate the flow of molten material injected into the mold cavity.

The movable coupling between the elements 20, 40 allows the displacement of the element 20 with respect to the element 40 along the axis Y1 (or Y2) to adjust the relative position between the elements 20, 40 and ensure the coupling of the conical surfaces with the corresponding ones made on the mold plate 12.

The structure of the insert 10 then allows correctly locating both elements 20, 40 within the plate 12, since the thread 28, 48 allows adjusting the total height of the insert 10. In particular, by means of the afore-mentioned positional adjustment, the correct functionality of the gaskets 18 can be obtained in addition to the correct coupling of the conical zones of the element 20.

Generally, the coolable insert 10 is supplied/manufactured by the hot runner supplier, while the mold plate is made by the mold-maker. The described coolable insert allows compensating for any inaccuracies in the mechanical machining of the seat.

The making of the insert 10 in two separate elements 20, 40 also allows optimizing the materials used because the element 20 is subject to greater wear. Indeed, it is subject to the friction of the molten material. It is therefore possible to use more resistant materials for the element 20, consequently more expensive, and to replace it more easily and economically.

The elements 20, 40 preferably comprise two respective circular areas 60, 70 of mutual abutment. In the variant of FIG. 2, the circular area 70 is located on the outer surface of the bottom 44. Then the elements 20, 40 are couplable by mounting the element 20 on the outside of the bottom 44 and then screwing them together.

FIG. 3 shows a variant of coolable insert 80, which like the insert 10 is composed of the assembly of a lower element 82 and an upper element 84, The element 82 is made substantially like the element 20, while the element 84 is made substantially like the element 40.

In this variant, there is no end-stroke abutment between the lower element 82 and the upper element 84, the former being able to be screwed into the latter limitlessly. That is, the lower element 82 and the upper element 84 are structured in such a way that the element 82 can be inserted into the element 84 from above and then screwed in until the conical surface of the lower element 82 abuts against a complementary surface of the plate 12.

Thus, the elements 82, 84 are couplable by mounting the element 82 inside the bottom of the element 84 and then screwing them together, e.g. by using a wrench or special tool 90. The latter is also used to modify/calibrate the vertical position of the element 82 so as to position the aforementioned conical surfaces correctly, and compensate for any play or error.

The lower shape of the element 20, cylindrical or with tapered tip, results in a larger or smaller influence/trace on the finished piece.

FIGS. 2-3 illustrate inter alia a method for mounting the coolable insert 10, 80 in a mold. The insert 10, 80 is inserted into a complementary cavity of the mold plate 12. The second mold plate 14 has a pass-through opening 14a bounded by edges, and is directly superimposed on the cavity 12 so that the pass-through opening 14a is coaxial to the insert 10, 80 and its edges abut against the upper end of the cylindrical walls 45.

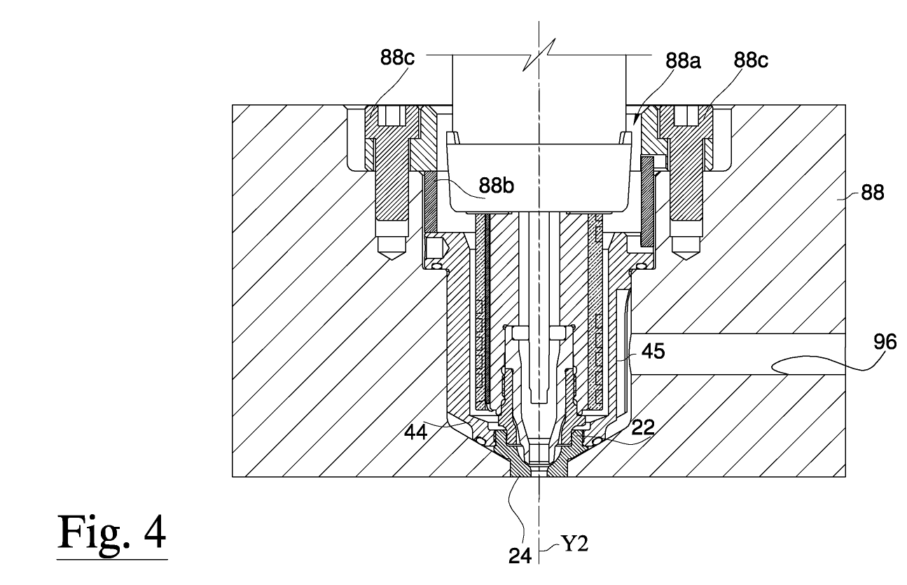

According to another variant, see FIG. 4, the insert 10, 80 is mounted in a complementary cavity 88a of a plate 88. A ring 88b is directly superimposed to and abutting against the upper end of the lateral walls 45, and is attached to the plate 88 by means such as screws 88c.

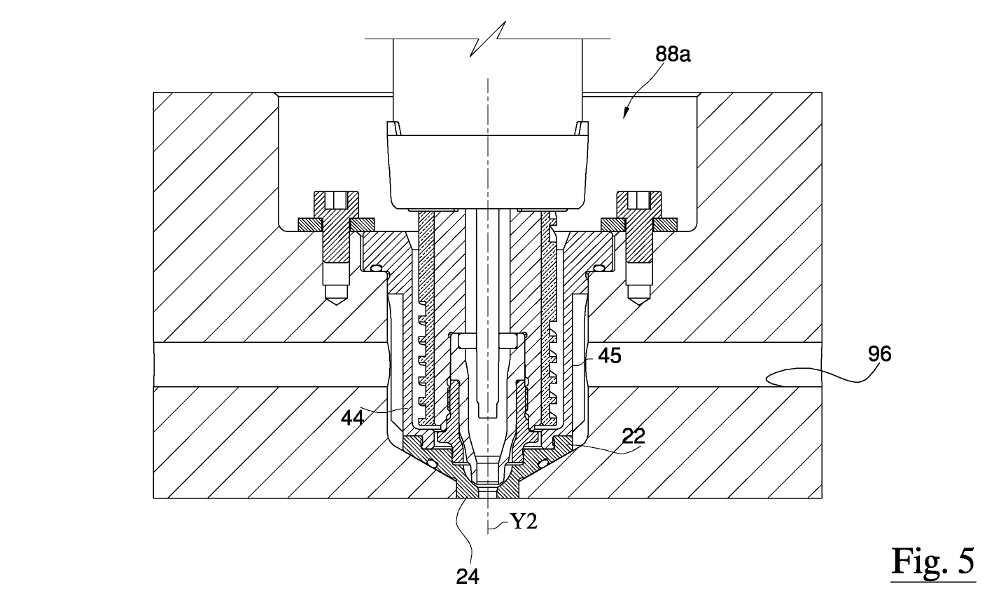

FIG. 5 shows a different version, in which the element 20 is fixed to the element 40 via an internal rather than external thread.

The types of mounting shown can be used for any variant of the insert.

Note that the invention is also applicable in systems with pinless injectors, called torpedo or free-flowing injectors.

1. Insert adapted to be placed at a gate of an injection molding machine around a tip of a molten material injector,
the molten material injector having a body,
the insert comprising
- a cup-shaped first element comprising
lateral walls that delimit a first opening for housing the injector body, and
a bottom centrally provided with a second opening (46),
- a second element (20), provided with a third central opening having a major dimension that is smaller than that of the second opening (36),
the second element (20) being provided with
a third central opening having a major dimension that is smaller than that of the second opening (36),
a major diameter that is substantially equal to that of the second opening (36),
the second element being connectable to said bottom (44 ) so that the second and third opening are aligned,
wherein the second opening has edges and the second element is connectable to the edges of the second opening.

2. Insert according to claim 1, wherein
the first and second opening have a center, and
the first element comprises an axis of substantial symmetry that is orthogonal to the bottom and passing through the center of the first and second opening, and
the second element is movably connected to the first element so that it can move along said axis and thereby adjust its relative position with respect to the first element.

3. Insert according to claim 1, wherein the first and second element comprise respective threads through which they can be coupled together by screwing one with the other.

4. Insert according to claim 2, wherein the first and second element comprise respective threads through which they can be coupled together by screwing one with the other.

5. Insert according to claim 3, wherein
the second opening have margins, and
the thread of the first element is placed on the margins of the second opening.

6. Insert according to claim 4, wherein
the second opening have margins, and
the thread of the first element is placed on the margins of the second opening.

7. Insert according to claim 4, wherein the second element comprises a circular bushing-shaped portion comprising a lateral surface on which said thread is provided,
the circular bushing-shaped portion extending with a tapered portion.

8. Insert according to claim 5, wherein the second element comprises a circular bushing-shaped portion comprising a lateral surface on which said thread is provided,
the circular bushing-shaped portion extending with a tapered portion.

9. Insert according to claim 6, wherein the second element comprises a circular bushing-shaped portion comprising a lateral surface on which said thread is provided,
the circular bushing-shaped portion extending with a tapered portion.

10. Insert according to claim 7, wherein the tapered portion has a conical shape.

11. Insert according to claim 8, wherein the tapered portion has a conical shape.

12. Insert according to claim 9, wherein the tapered portion has a conical shape.

13. Insert according to claim 1, wherein the first and second elements comprise two respective circular areas for reciprocal abutting,
said bottom comprising an external surface,
the circular abutting area of the first element being placed on the external surface of the bottom.

14. Insert according to claim 1, wherein the first and second element are structured so that the second element is snugly insertable into, and can pass through the, second opening.

15. Insert according to claim 2, wherein the first and second element are structured so that the second element is snugly insertable into, and can pass through the, second opening.

16. Insert according to claim 3, wherein the first and second element are structured so that the second element is snugly insertable into, and can pass through the, second opening.

17. Insert according to claim 1, wherein
the lateral walls of the first element comprise an outer surface,
the outer surface of the lateral walls of the first element comprising at least one groove for cooling fluid.
